(19) United States
(12) Patent Application Publication
(10) Pub. No.: US 2025/0062510 A1
(43) Pub. Date: Feb. 20, 2025

(54) TERMINAL RIVET ASSEMBLY FOR A BATTERY CELL

(71) Applicant: NORTHVOLT AB, Stockholm (SE)

(72) Inventors: Dennis BEIN, Västerås (SE); Martin FRANZÉN, Surahammar (SE); Josefine LARSEN, Västerås (SE)

(21) Appl. No.: 18/792,051

(22) Filed: Aug. 1, 2024

(30) Foreign Application Priority Data
Aug. 16, 2023 (SE) 2350972-2

(51) Int. Cl. H01M 50/567; B21J 15/04; H01M 50/152; H01M 50/179; H01M 50/184; H01M 50/188; H01M 50/531; H01M 50/559; H01M 50/588; H01M 50/59

(52) U.S. Cl. CPC H01M 50/567; B21J 15/046; H01M 50/152; H01M 50/179; H01M 50/184; H01M 50/188; H01M 50/531; H01M 50/559; H01M 50/588; H01M 50/59

(57) ABSTRACT

There is disclosed herein a method for riveting a terminal rivet for a cylindrical secondary cell, wherein the terminal rivet comprises a head and a shaft extending from the head. The method comprises the steps of arranging the shaft of the terminal rivet axially through an opening in a casing of the secondary cell such that the head of the terminal rivet abuts an external surface of the casing to thereby form an external terminal for the secondary cell. The method further comprises the step of deforming the shaft against an internal surface of the casing, and deforming the head against the external surface of the casing towards the deformed shaft.

### BACKGROUND

### Related Field

The present disclosure relates to a terminal rivet for a secondary cell, a secondary cell comprising the terminal rivet, and a method of manufacturing such a secondary cell.

### Related Art

In addressing climate change, there is an increasing demand for rechargeable batteries, e.g., to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### BRIEF SUMMARY

The present disclosure aims to provide improved secondary cells and parts thereof. The improvements may be in energy performance, manufacturing efficiency, decreased amount of material used, and assembly simplification, among others.

In particular, according to an aspect of the present disclosure, there is provided a method for riveting a terminal rivet for a cylindrical secondary cell. The terminal rivet comprises a head and a shaft extending from the head. The method comprises arranging the shaft of the terminal rivet axially through an opening in a casing of the secondary cell such that the head of the terminal rivet abuts an external surface of the casing (which is preferably part of a gasket for sealing the opening in the casing) to thereby form an external terminal for the secondary cell. Further, the method comprises deforming the shaft against an internal surface of the casing (said surface also being preferably protected by a gasket or similar component). Even further, the method comprises deforming the head against the external surface of the casing towards the deformed shaft. Thus, the terminal rivet is deformed in two areas to ensure that it is properly riveted. The second deformation, i.e. the deformation of the head, further ensures that there is no leakage from the inside of the casing to the outside of the casing.

Thus, according to a further aspect of the present disclosure, there is provided a terminal rivet for a cylindrical secondary cell, the terminal rivet being formed from the method as described above. The terminal rivet may, according to an aspect of the present disclosure, comprise, in a riveted state, a shaft configured to extend axially through a casing of the secondary cell to thereby electrically contact a current collecting plate of the secondary cell at a first end of the shaft, although in alternative arrangements the terminal rivet may directly contact the electrode assembly, e.g., exposed uncoated tabs thereof. The terminal rivet may further comprise a head arranged at a second end of the shaft, configured to form an external terminal for the secondary cell. The shaft may comprise a first deformation region bent towards an internal surface of the casing. The head may comprise a second deformation region bent towards an external surface of the casing.

The conventional way of riveting a terminal rivet by deforming the terminal rivet on an inside of the casing, may cause cavities between the components during riveting, due to deformation of the components relative to each other. In particular, the casing itself may be slightly deformed as a result of applying an external riveting pressure, which may cause a leakage of electrolyte from the casing. Thus, by including a second deformation region, deforming the terminal rivet on an outside of the casing, this leakage may be prevented by ensuring that the terminal rivet is properly clamped to the casing.

In an unriveted state, i.e. before being deformed, the head may be substantially flat. For example, the head of the terminal rivet may have a substantially circular shape (when viewed along the longitudinal axis of the cylindrical cell). The area of the top surface of the head may thus be flat prior to riveting. Further, the shaft may extend from a center of the head. The shaft may be annular, and may, in an unriveted state, have the shape of a hollow cylinder.

According to a further aspect of the present disclosure, there is provided a cylindrical secondary cell comprising an electrode roll housed in a cylindrical casing having an opening therein for receiving a rivet. The secondary cell further comprises a terminal rivet according to the previous aspects of the present disclosure. The shaft of the terminal rivet extends through the opening in the casing. The secondary cell further comprises a current collecting plate in direct electrical contact with the electrode roll, wherein the first end of the shaft of the terminal rivet is in direct electrical contact with the current collecting plate.

The opening of the casing of the secondary cell may have a substantially circular shape. The diameter of the opening may be smaller than that of the head, such that the head may rest on an external surface of the casing, this being protected by a gasket to prevent direct electrical contact between the rivet and the casing. Further, the diameter of the shaft may be smaller than that of the opening in the casing, such that the shaft may extend through the opening.

The deformation of the shaft and the head may be a result of an external pressure applied on the head of the terminal rivet, where a counter-pressure is applied to the shaft (e.g., by resting the shaft on a surface), or vice versa. The pressure applied on the head may result in the shaft being bent outwards towards the internal surface of the casing. The terminal rivet may be arranged to abut the current collecting plate in order to form the direct electrical contact therebetween. Thus, when an external pressure is applied to the head of the terminal rivet, the shaft may be pressed against a surface which provides a counter force, causing the shaft to deform. In the example where the shaft is formed as a hollow cylinder, the end of the shaft may be bent outwards from the axial direction in which it extends, forcing it back on itself and thereby towards an internal surface of the casing. Thus, the first deformation region of the shaft may comprise the end of the shaft. The internal surface of the casing may be located in a top part of the casing, i.e. the same part where the opening is located.

Further, the head may be deformed by a second deformation region being bent against an external surface of the casing. The head may comprise an outer region and a central region, where the outer region surrounds the central region. In the example where the head is substantially circular, the central region may be circular and the outer region(s) may be annular. The second deformation region of the head may thus be the outer region. The central region of the head may remain flat after riveting. The deformation region of the head may constitute 10 to 30% of a total area of the head. In a preferred embodiment, the deformation region constitutes 10% of the total area of the head. By total area of the head may be meant the area of the top surface of the head, i.e. the central region and the second deformation region. It is advantageous to maximize the flat portion of the head since a larger area increases the area available for electrical connection.

Thus, deforming of the head includes pressing a riveting surface against at least an annular deformation region surrounding a central region of the head. The riveting surface applying the external pressure on the head may be a part of a pressing tool, a riveting tool, or any other tool suitable for providing a pressure or counter-pressure when riveting a terminal rivet. The annular deformation region may be the second deformation region, in the case where the head is substantially circular and the second deformation region is also circular. The second deformation region is deformed as a result of an external pressure being applied to the head, and bent towards an external surface of the casing. As earlier discussed, the diameter of the head of the terminal rivet is greater than a diameter of the opening of the casing where the shaft is arranged. Thus, at least a part of the outer region of the head may rest against an external surface of the casing. When deformed, the second deformation region of the head is bent towards the external surface of the casing, such that the second deformation region is clamped against the casing. Since the shaft may be bent towards an opposite internal surface of the casing, the terminal rivet may be clamped around the opening of the casing.

In one example, deforming of the shaft and deforming of the head are carried out substantially simultaneously. The present disclosure is advantageous in that it facilitates manufacturing, since two steps may be carried out simultaneously, even by the same tool, which may save time and costs during the manufacturing process.

The terminal rivet preferably comprises a gasket arranged between the terminal rivet and the casing, wherein the gasket is configured to electrically insulate the terminal rivet from a cell lid of the secondary cell. The gasket may thus have the same or a greater diameter than the head of the terminal rivet. Further, the gasket may be arranged to extend along the external surface of the casing, extend through the opening of the casing, and extend along an internal surface of the casing. The gasket may further be arranged to lay against the casing on the external surface, the opening of the casing and the internal surface of the casing. Thus, according to this embodiment, the first and second deformation regions of the terminal rivet may be clamped around the gasket. The gasket may be made of a non-conductive, ductile material, such that the first and second deformation regions of the terminal rivet may bite into the gasket upon deformation. This causes tight seal between the terminal rivet and the casing, preventing leakage.

To further ensure a tight seal between the terminal rivet and the sealing, the terminal rivet may comprise a protrusion on a surface of the head facing the external surface of the casing. The protrusion may thus be arranged on the second deformation region. The protrusion may be annular, and continuous or intermittent around the circumference of the head. Thus, the protrusion may thus be concentric with the shaft of the terminal rivet. For example, the protrusion may be a number of ridges distributed around the head, or one continuous annular protruding rib. It will be appreciated that other possible embodiments of the protrusion are also possible. The protrusion may enhance the grip between the terminal rivet and the gasket and/or casing. The external pressure acting on the head may be more concentrated at the protrusions, resulting in these protrusions being more reliably clamped against the gasket and/or casing.

In a further example, the casing and/or the gasket may comprise a recess configured to receive the protrusion(s). The recess may have the same shape and distribution as the protrusion(s) to form a mating coupling therebetween. Thus, when the head is deformed, the protrusion(s) may be pressed into the recess(es) and thereby forming a tight seal. Further, the mating between the protrusion(s) and the recess(es) may ensure that the terminal rivet is riveted in the desired position. This is advantageous since it enhances the reliability of the cylindrical secondary cell, as it ensures that the terminal rivet is riveted in the desired position during manufacture. This may also decrease the number of manufacturing errors. The recess(es) may, in other examples, have a different shape than the protrusion(s), e.g. a smaller size or a different ‘geometrical’ shape (for example round instead of quadratic). When the protrusion(s) is then pressed into the recess(es), it may create a greater compressing force on the gasket/casing, thereby forming a tight seal.

According to a further aspect of the present disclosure, there is provided a riveting apparatus for riveting a terminal rivet to a secondary cell, comprising a pressing surface configured to apply a pressure to a head of a terminal rivet. The pressing surface comprises a first pressing region and a second pressing region arranged around the first pressing region. The first pressing region (or at least a part thereof) is recessed relative to the second pressing region. The riveting apparatus may be used to rivet the terminal rivet according to previously discussed disclosures. The riveting apparatus may be formed as a piston, for example.

### BRIEF DESCRIPTION OF THE FIGURES

One or more embodiments will be described, by way of example only, and with reference to the following figures, in which:

FIG. 1 illustrates a method of riveting a terminal rivet according to aspects of the present disclosure;

FIG. 2 schematically shows a cylindrical secondary cell according to aspects of the present disclosure;

FIGS. 3A to 3B schematically shows cross-sectional views of a terminal rivet in an unriveted and riveted state according to aspects of the present disclosure;

FIGS. 4A to 4B schematically shows cross-sectional views of a terminal rivet in an unriveted and riveted state according to aspects of the present disclosure;

FIGS. 5A to 5b schematically shows cross-sectional views of a terminal rivet in an unriveted and riveted state according to aspects of the present disclosure;

FIG. 6 shows a top view of a terminal rivet according to aspects of the present disclosure.

### DETAILED DESCRIPTION

The present disclosure is described in the following by way of a number of illustrative examples. It will be appreciated that these examples are provided for illustration and explanation only and are not intended to be limiting on the scope of protection. Instead, the scope of the present disclosure is defined by the appended claims.

Furthermore, although embodiments be presented individually for the sake of focused discussion of particular features, it will be recognized that the present disclosure also encompasses combinations of the embodiments described herein.

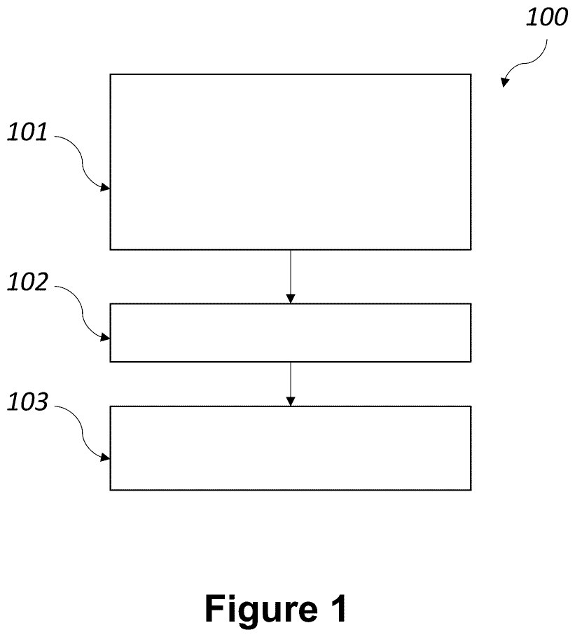

FIG. 1 illustrates a method 100 of riveting a terminal rivet 200 according to aspects of the present disclosure. In one example, as shown in the present figure, the method 100 comprises a number of steps, wherein the first step 101 comprises arranging the shaft 220 of the terminal rivet 200 axially through an opening 311 in a casing 310 of the secondary cell 300 such that the head 210 of the terminal rivet 200 abuts an external surface 312 of the casing 310 to form an external terminal for the secondary cell 300.

The step 102 subsequent to the first step 101 includes deforming the shaft 220 towards/against an internal surface 313 of the casing 310.

Finally, the method includes the step 103 of deforming the head 210 towards/against the external surface 312 of the casing 310, thereby towards the deformed shaft 220. The method steps 102 and 103 may be performed simultaneously.

By manufacturing the secondary cell 300 according to such a method 100, having many advantageous features as described above, the cell 300 may be produced to prevent leakage and securely riveting the terminal rivet 200 into a desired position in the casing 310. The method 100 may be readily automated as part of a wider cell manufacture and assembly process, for example.

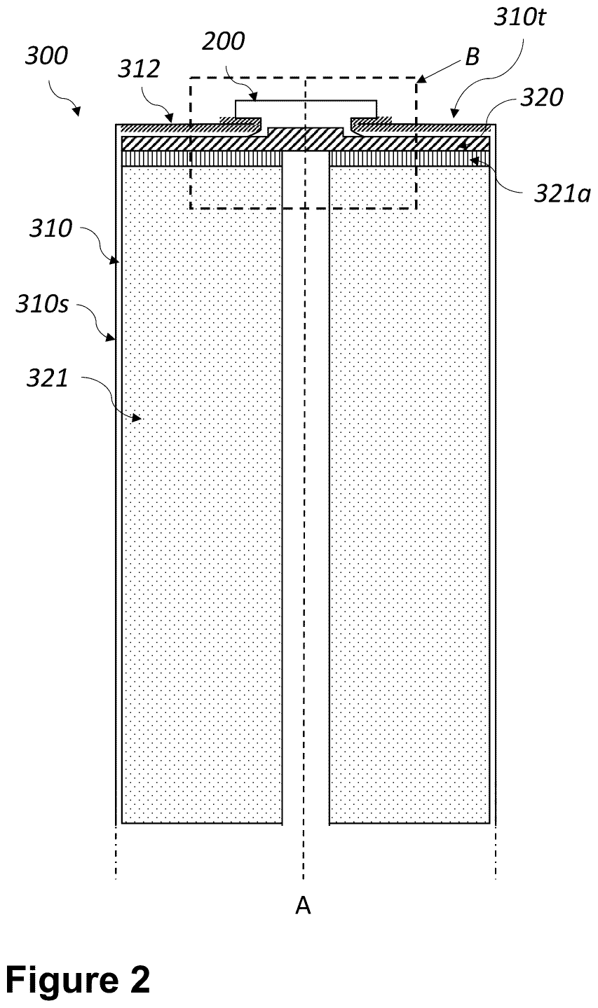

FIG. 2 schematically shows a cross-sectional view of a secondary cell 300 according to aspects of the present disclosure, also referred to herein as simply a ‘cell 300’. In the illustrated example, a cell 300 is shown having a cylindrical casing 310 extending along a center axis A. It will be appreciated that the illustrated cylindrical secondary cell 300 is purely illustrative and that the presently disclosed aspects could, with appropriate adaptations, be applied to prismatic cells.

The cylindrical casing 310 extends along an axis A between a first end 310t, which may be referred to as a ‘top end 310t’, and a bottom end (not shown) which may be an open end of the casing 310 closed by a lid. The closure of the casing may comprise a clamped closure or a welded closure, depending on the implementation.

For example, the casing 310 may further comprise a beading groove (not shown) formed in the side wall 310s. Hence, between the beading groove and the end edge of the side wall towards the bottom end of the casing, a clamping portion can be formed. A lid gasket may then be clamped around the bottom lid in the clamping portion to thereby seal the open bottom end of the casing. Providing a clamped closure in this way is well known in the art and thus can provide a reliable waterproof seal for the cell.

As another example, the lid may be welded to the casing to thereby seal the casing. The lid may be additionally welded to a current collector, or the lid may act as a current collector itself and be attached (e.g., welded) to the tabs of the electrode roll 321. Providing a welded closure in this way may advantageously remove the number of components of the cell and/or the number of process steps required to manufacture the cell.

A cathode current collecting plate 320 is arranged in direct electrical contact with the cathode tabs 321a and an anode current collecting plate (not shown) may be arranged in direct electrical contact with the anode tabs (also not shown). Here, the labels ‘cathode’ and ‘anode’ may be swapped. Thus, an electrical connection is formed from the cathode tabs 321a to the terminal assembly, as the terminal assembly is connected to the current collecting plate 320.

An electrical connection may also formed from the anode tabs to the casing 310, either directly or through connection of an anode current collecting plate to the casing 310, e.g. in the clamping portion or by welding. One or both or the current collectors may be formed as a disc, a plate, or have some other shape.

At either end of the cell, the cell may further comprise a vent for venting gases, for example during a failure of the cell. Moreover, the cell may comprise an additional through-hole, in the casing and/or the lid, for filling the cell with a liquid electrolyte. This through-hole is preferably adapted to be closed from the outside, such as through the use of a blind rivet.

The cell 300 includes, as mentioned, a casing 310, housing a current collecting disc 320 and an electrode roll 321. In one end of the casing 310, i.e. the top end 310t in the figure, there is an opening 312 for receiving a terminal rivet 200. The opening 312 may be situated in a cell lid of the casing 310. The cell lid may for example constitute the entire top side of the cell 200. The terminal rivet 200 is inserted axially into the opening 312, and thereafter arranged in electrical contact with the current collecting disc 320 inside the casing 310 to thereby provide a current path between, e.g., a cathode connection to the electrode roll 321 and the head of the rivet 200. The terminal rivet 200 will be described in more detail in the following figures, which show the area bounded by rectangle B in FIG. 2.

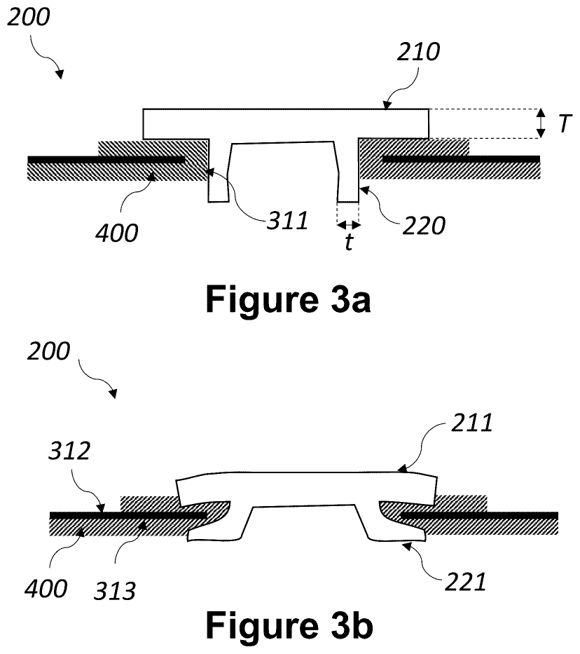

FIGS. 3A and 3B schematically shows cross-sectional views of a terminal rivet 200 in an unriveted and riveted state, respectively, according to aspects of the present disclosure. FIG. 3A shows the terminal rivet 200 in an unriveted state, i.e. after step 101 but before step 102 of the method 100 shown in FIG. 1. The terminal rivet 200 comprises a head 210 arranged on an outside of the casing 310. The head may be substantially circular when looking at it from a top view, and have a thickness T. It will be appreciated that other shapes of the terminal rivet 200 are also possible, such as rectangular, quadratic or oval, and the thickness may instead be irregular. As illustrated, the bottom side of the head 210 abuts the external surface of the casing 310. Furthermore, the bottom and top sides of the head 210 are substantially parallel in the unriveted state, as illustrated in the present figure. In other embodiments, however, the bottom and top sides of the head 210 may be non-parallel, and instead angled relative each other. The bottom and top sides of the head 210 may also be substantially parallel with the outer surface 312 of the casing 310.

The shaft 220 of the terminal rivet is axially arranged through the opening 311 of the casing 310. The shaft 220 may have a hollow shape, e.g., a hollow cylinder, in the cross-sectional view in the present figure seen as two ‘legs’ extending from the bottom of the head 210. In the case where the head 210 is substantially circular, the head 210 may have a greater diameter than the shaft 220, meaning that the edges of the head 210 may prevent the terminal rivet 200 from being inserted into and through the opening 311 of the casing 310. Thereby, only the shaft 220 is allowed to be inserted through the opening 311, and the edges of the head 210 rests against the external surface 312 of the casing 310. The ‘legs’ of the shaft 220 has a thickness t. The thickness t of the ‘legs’ may be smaller than the thickness T of the head 210. In another example, the thickness t of the ‘legs’ may be greater than the thickness T of the head 210.

Between the terminal rivet 200 and the casing 310 there is a gasket 400. The gasket 400 may, as illustrated in the figure, hug the edges of the opening 311 of the casing 310. By hugging is meant that the gasket 400 extends along an external surface 312 of the casing 310, through the opening 311 and along the internal surface 313 of the casing 310. Thus, no part of the terminal rivet 200 may be in contact with the casing 310. In this way, the gasket 400 insulates the terminal rivet 200 from the casing 310, or cell lid comprising the opening 312.

FIG. 3b illustrates the terminal rivet 200 after steps 102 and/or 103 of the method 100 shown in FIG. 1 have been performed, i.e. the terminal rivet 200 is illustrated in a riveted state. The edge of the head 210 has been deformed at a second deformation region 211. The second deformation region 211 may be formed by applying a riveting tool (not shown) to the head 210. The riveting tool may deform the head 210 by applying pressure to the second deformation region 211 of the head 210, for example. It will be appreciated that other types of methods of deforming the head 210 are possible. The second deformation region 211 may be annular around the periphery of the head 210.

The gasket 400 may be made of a ductile material, and thus when the head 210 is deformed and pushed downwards towards the gasket 400, the gasket 400 may, due to its ductile characteristics, absorb some of the force such that the deformation region 211 of the head 210 bites into the gasket 400, while the external surface 311 of the casing 310 does not deform. This ensures a tight coupling between the terminal rivet 200 and the gasket 400 simultaneously forming a tight seal between the casing 300 and the terminal rivet 200.

FIG. 3b also illustrates the shaft 220 of the terminal rivet 200 in a deformed state. The shaft 220 has been deformed in a first deformation region 221. The first deformation region 221, as seen in the figure, is situated at the lower end of the shaft 220, i.e. the end of the shaft 220 that is opposite to the end of the shaft 220 that is attached to the head 210. The deformation of the shaft 220 may be a result of applying a riveting tool (not shown) to the head 210, i.e., via a counter-pressure against some surface. The riveting tool may deform the shaft 220 by applying a pressure to the head 210 of the terminal rivet 200 causing both the second deformation region 211 and the first deformation region 221 to deform. Alternatively, the riveting tool may be applied to the shaft 220 such that the head 210 is deformed by counter-pressure against some surface. The first deformation region 221 may be bent outwards away from the center axis A of the cell 300. Thus, the first deformation region 221 may be bent towards the internal surface 313 of the casing 310.

Since the gasket 400 extends along the internal surface 313 of the casing 310, the ductile characteristics of the gasket 400 may absorb some of the force applied to the terminal rivet 200 such that the first deformation region 221 bites into the gasket 400, while the internal surface 313 of the casing 310 is not deformed. The deformation of the shaft 220 ensures that the terminal rivet 200 stays in place in the casing 310, such that it can no longer be extracted from the opening 211 thereof. Further, the first and second deformation regions 221, 211 together clamps around the opening 311 of the casing 310, forming a sealed area, which prevents leakage of electrolyte from inside the cell 300 to the outside.

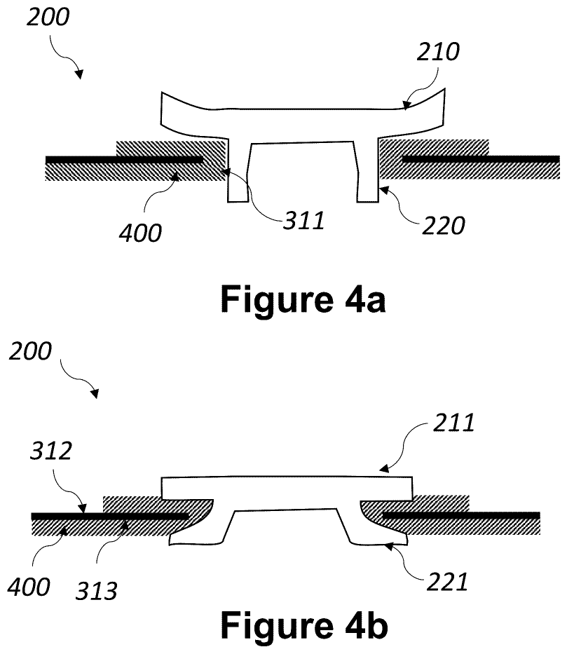

FIGS. 4a and 4b schematically show another exemplifying embodiment of a cross-sectional view of a terminal rivet 200 in an unriveted and riveted state according to aspects of the present disclosure. As seen in FIG. 4a, the head 210 of the terminal rivet 200 is not parallel with the external surface 312 of the casing 310 before riveting. Instead, the edges of the head 210 are slightly bent away from the external surface 312 of the casing 310. The bent edges of the head 210 may correspond to the second deformation region 211, as seen in FIG. 4b. Thus, when the terminal rivet 200 is deformed, the second deformation region 211 may be deformed and thereby become parallel with the external surface 312 in the riveted state.

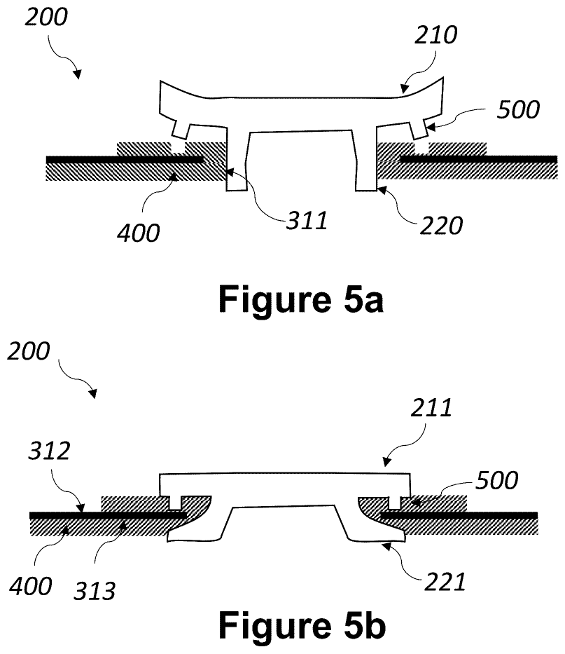

A further exemplifying embodiment of the terminal rivet 200 is illustrated in FIGS. 5a and 5b. In this example, the head 210 of the terminal rivet 200 comprises a protrusion 500. The protrusion 500 protrudes from the side of the head 210 facing the external surface 312 of the casing 310. The protrusion 500 may be continuous or annular around a periphery of the head 210. In FIGS. 5a and 5b the protrusion 500 is shown in the example where the head 210 of the terminal rivet 200 is not parallel with the external surface 312 of the casing 310. It will be appreciated, that the protrusion 500 may be combined with the example where the head 210 is parallel with the external surface 312 of the casing 310 as well.

The gasket 400 comprises a recess 510 for receiving the protrusion 500. The recess 510 may be of substantially the same size and shape as the protrusion 500, to form mating parts. In the riveted state, as shown in FIG. 5b, the protrusion 500 is pressed into the recess 510 thereby biting into the gasket 400. As mentioned above, the recess 510 may, in other examples, have a different shape than the protrusion 500, e.g. a smaller size or a different ‘geometrical’ shape (for example round instead of quadratic). When the protrusion 500 is then pressed into the recess 510, it may create a greater compressing force on the gasket 400, thereby forming a tight seal by biting into the gasket 400.

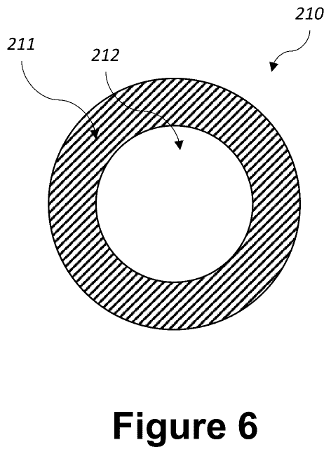

FIG. 6 shows a top view of a terminal rivet 200 according to aspects of the present disclosure. In this exemplifying embodiment, the head 210 of the terminal rivet 200 is substantially circular from a top view. Furthermore, it is seen that the second deformation region 211 is annular around the periphery of the head 210. The central region 212 of the head 210 constitutes the part of the head 210 that does not deform during riveting.

While the present disclosure is susceptible to various modifications and alternative forms, specific embodiments are shown and described above by way of example in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims.

1-12. (canceled)

13. A method (100) for riveting a terminal rivet (200) for a cylindrical secondary cell (300), wherein the terminal rivet (200) comprises a head (210) and a shaft (220) extending from the head (210), said method comprising the steps of:
arranging (101) the shaft (220) of the terminal rivet (200) axially (A) through an opening (311) in a casing (310) of the secondary cell (300) such that the head (210) of the terminal rivet (200) abuts an external surface (312) of the casing (310) to thereby form an external terminal for the secondary cell (300);
deforming (102) the shaft (220) towards an internal surface (313) of the casing (300); and
deforming (103) the head (210) towards the external surface (312) of the casing (300), thereby towards the deformed shaft (220).

14. The method (100) according to claim 13, wherein said steps of deforming (102, 103) the shaft (220) and the head (210) are carried out substantially simultaneously.

15. The method (100) according to claim 14, wherein deforming (103) the head comprises pressing a riveting surface against at least an annular deformation region (211) surrounding a central region (212) of the head (210).

16. Method (100) according to claim 15, wherein the deformation region (211) constitutes 10 to 30% of a total area of the head (210).

17. The method (100) according to claim 13, wherein deforming (103) the head comprises pressing a riveting surface against at least an annular deformation region (211) surrounding a central region (212) of the head (210).

18. A terminal rivet (200) for a cylindrical secondary cell (300) comprising, in a riveted state:
a shaft (220) configured to extend axially (A) through a casing (310) of the secondary cell (300) to thereby electrically contact a current collecting plate (320) of the secondary cell (300) at a first end of the shaft (220); and
a head (210) arranged at a second end of the shaft (220), configured to form an external terminal (200) for the secondary cell (300),
wherein:
the shaft (220) comprises a first deformation region (221) bent towards an internal surface (313) of the casing; and
the head (210) comprises a second deformation region (211) bent towards an external surface (312) of the casing (310).

19. The terminal rivet (200) according to claim 18, further comprising a protrusion (500) on a surface of the head (213) facing the external surface of the casing (312).

20. The terminal rivet (200) according to claim 19, wherein the protrusion (500) is arranged on the second deformation region (211).

21. A cylindrical secondary cell (300), comprising:
an electrode roll (321) housed in a cylindrical casing (310) having an opening (311) therein for receiving a rivet (200); and
the terminal rivet (200) according to claim 18, wherein the shaft (220) of the terminal rivet (200) extends through the opening (311) in the casing (310); and
a current collecting plate (320) in direct electrical contact with the electrode roll (321), wherein the first end of the shaft (220) of the terminal rivet (200) is in direct electrical contact with the current collecting plate (320).

22. A cylindrical secondary cell (300), comprising:
an electrode roll (321) housed in a cylindrical casing (310) having an opening (311) therein for receiving a rivet (200); and
the terminal rivet (200) according to claim 19, wherein the shaft (220) of the terminal rivet (200) extends through the opening (311) in the casing (310); and
a current collecting plate (320) in direct electrical contact with the electrode roll (321), wherein the first end of the shaft (220) of the terminal rivet (200) is in direct electrical contact with the current collecting plate (320).

23. A cylindrical secondary cell (300), comprising:
an electrode roll (321) housed in a cylindrical casing (310) having an opening (311) therein for receiving a rivet (200); and
the terminal rivet (200) according to claim 20, wherein the shaft (220) of the terminal rivet (200) extends through the opening (311) in the casing (310); and
a current collecting plate (320) in direct electrical contact with the electrode roll (321), wherein the first end of the shaft (220) of the terminal rivet (200) is in direct electrical contact with the current collecting plate (320).

24. The cylindrical secondary cell (300) according to claim 21, further comprising a gasket (400) arranged between the terminal rivet (200) and the casing (310), wherein the gasket (400) is configured to electrically insulate the terminal rivet (200) from a cell lid of the secondary cell (300).

25. The cylindrical secondary cell (300) according to claim 24, wherein the casing (310) and/or the gasket (400) comprises a recess (510) configured to receive the protrusion (500).

26. The cylindrical secondary cell (300) according to claim 21, wherein the casing (310) and/or the gasket (400) comprises a recess (510) configured to receive the protrusion (500).

27. A riveting apparatus for riveting the terminal rivet (200) according to claim 18 to a cylindrical secondary cell (300), the riveting apparatus comprising:
a pressing surface configured to apply a pressure to a head of a terminal rivet (200),
wherein the pressing surface comprises a first pressing region and a second pressing region arranged around the first pressing region, said first pressing region being recessed relative to the second pressing region.
